(19) United States
(12) Patent Application Publication
(10) Pub. No.: US 2016/0140429 A1
(43) Pub. Date: May 19, 2016

(54) SYSTEM AND METHOD FOR CONVEYANCE OF MODULE STATE INFORMATION

(71) Applicant: General Electric Company, Schenetady, NY (US)

(72) Inventors: Richard Joseph GLOSSER, Salem, VA (US); Shawn Hinchy, Roanoke, VA (US)

(21) Appl. No.: 14/547,773

(22) Filed: Nov. 19, 2014

(51) Int. Cl. G06K 19/06; G06K 7/14; G01M 99/00

(52) U.S. Cl. CPC G06K 19/06075; G01M 99/008; G06K 7/1417; G06K 19/06037; G06K 19/06112

(57) ABSTRACT

A control module comprising a display, according to various embodiments, can include an input/output module configured to receive one or more signals responsive to a state of at least one diagnostic sensor, the state being indicative of at least one from the group including a fault, an error, and a malfunction. A processor is configured to match values of the received signals to one of a plurality of stored table values to identify a matching value, each matching value corresponding to a code. A barcode generator creates a two-dimensional barcode representative of the code and outputs the barcode to the display. In one embodiment, the diagnostic sensor can be an internal diagnostic sensor within the control module capable of performing self-diagnostics. In another embodiment, the diagnostic sensor can be an external diagnostic sensor associated with an external device for performing remote diagnostics.

### FIELD OF THE INVENTION

The present disclosure relates generally to service and maintenance of a device. More particularly, the present disclosure relates to a system and method for gathering information for monitoring and diagnosing the condition of the device.

### BACKGROUND OF THE INVENTION

Traditionally, when a device fails to operate as designed, a technician may be called to the site for troubleshooting the problem. Typically, the technician confirms the malfunctioning device by a solid or blinking indicator light on the device. The technician may perform a series of checks in an attempt to isolate the problem. Data may be gathered from the suspected malfunctioning device by reading static barcodes or text data printed on physical labels or light emitting diode (LED) indications or other visual data communication method. This type of data only provide basic information about the physical hardware, In addition, labels, which are attached to the suspected malfunctioning device, may contain only a minimal amount of information, and sometimes this information can be hidden by location, wiring, or poor lighting. This can lead to a part number error should the device require replacement.

If the device is a component within a system or network, additional complications may exist in determining the cause of the problem. Within a system or a network, many causes may be attributed to other components that can affect the performance of the suspected malfunctioning device. Thus, it may be even more difficult to analyze the system's problems and operating patterns to determine whether the device is faulty or if the problem lies elsewhere in the system.

This confusion of causes may result in the unnecessary replacement of a good piece of equipment, which is a costly diagnostic error. Further aggravating the problem is that the root cause remains unresolved, and the problem most likely will reoccur. Any tool which can help avoid misdiagnosing of the underlying failure would prove to be both useful and cost effective.

Thus, there remains a need for a system and method that records the state of a device and then analyzes this state information to determine a faulty situation. There remains a need for a system and method that is capable of isolating the fault to either a suspected malfunctioning device or other components within a system. When a technician arrives onsite to troubleshoot the device, status information can be easily represented as a visual indicator containing dynamic and static diagnostic information obtained from the device.

The diagnostic information can be captured and stored by a portable, handheld device, such as a smart device carried by the technician. There is a further need for a system and method that avoids the situation of a misdiagnosis and the potential of mistakenly replacing a good piece of equipment. Thus, there remains a need for a system and method that enables a user to discover devices within a system and to identify which devices may be malfunctioning and the nature of any malfunctions that do occur.

### SUMMARY OF THE EMBODIMENTS OF THE INVENTION

In at least one aspect, the present disclosure provides an electronic control module, which includes an input/output module comprising an electrical circuitry subassembly. The electrical circuitry subassembly is initialized by instructions in a processing unit to perform an input/output function that converts electrical signals to input/output table values, which are then stored in a database. The electrical signals are received at respective input/output channels transmitted through connecting signal lines.

A barcode generator generates a two-dimensional barcode embedded with an operating state of at least one diagnostic sensor. In one embodiment, the diagnostic sensor can be an internal diagnostic sensor within the electronic control module for performing self-diagnostics. In another embodiment, the diagnostic sensor can be an external diagnostic sensor associated with an external device for remote diagnostics.

A display mechanism displays the two-dimensional barcode. A communication interface is configured to conduct a wireless transmission session over a network with a handheld device comprising a camera to capture an image of the two-dimensional code to decode and download data embedded within the two-dimensional barcode using a software application installed on the handheld device.

In at least another aspect, the present disclosure provides a method for conveying data stored within an electronic control module. In various embodiments, the method comprises the steps of receiving electrical signals at an input/output module responsive to a state of at least one diagnostic sensor; performing an input/output function by converting the electrical signals to input/output table values, which are then stored in at least one database; generating a two-dimensional barcode embedded with an operating state of the at least one diagnostic sensor; displaying the two-dimensional barcode; conducting a wireless transmission session over a network with a handheld device comprising a camera to capture an image of the two-dimensional code; and decoding and downloading data embedded within the two-dimensional barcode using a software application installed on the handheld device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1 illustrates an exemplary electronic control module equipped with a graphic display interface in accordance with the present disclosure;

FIG. 2 illustrates an exemplary electronic control module equipped with a graphic display interface displaying a two-dimensional barcode in accordance with the present disclosure;

FIG. 3 illustrates an exemplary gas turbine system for use with the diagnostic system in accordance with the present disclosure;

FIG. 4 illustrates a process flow diagram of a method for troubleshooting and diagnosing a device in accordance with the present disclosure; and

FIG. 5 illustrates an exemplary embodiment of basic components included within the electronic module in accordance with the present disclosure.

The present disclosure may take form in various components and arrangements of components, and in various process operations and arrangements of process operations. The present disclosure is illustrated in the accompanying drawings, throughout which, like reference numerals may indicate corresponding or similar parts in the various figures. The drawings are only for purposes of illustrating preferred embodiments and are not to be construed as limiting the disclosure. Given the following enabling description of the drawings, the novel aspects of the present disclosure should become evident to a person of ordinary skill in the art.

### DETAILED DESCRIPTION OF THE EMBODIMENTS

The following detailed description is merely exemplary in nature and is not intended to limit the applications and uses disclosed herein. Further, there is no intention to be bound by any theory presented in the preceding background or summary or the following detailed description.

As used herein, the term “computer” means a programmable device that responds to a specific set of instructions. A computer can be electronic or digital. The actual machinery, for example, wires, transistors, and circuits is called hardware and the instructions are called software.

Most computers typically comprise: a memory that enables a computer to store, at least temporarily, data and programs; and a mass storage device that allows a computer to permanently retain large amounts of data (common mass storage devices include disk drives and tape drives). Also included is an input device, for example, such as a keyboard or mouse, through which data and instructions enter a computer, an output device, for example, a display, screen or printer or other device that lets the user view what the computer has accomplished. A central processing unit (CPU), the component that executes instructions, is also included. In addition to these components, many other components make it possible for the basic components to work together efficiently. For example, most computers have a bus that transmits data from one part of the computer to another. Some examples of typical computers are a personal computer, a workstation, a processor, a minicomputer, a microprocessor, a multi-user computer, a mainframe, or a supercomputer.

As used herein, the term “database” means a collection of organized data. The data is typically organized for rapid search and retrieval by a computer.

As used herein, the term “Internet” means a global network of computers.

As used herein, the term “Intranet” means a secure network, typically belonging to an organization, for example, a corporation, accessible only by that organization's members, employees, or others with appropriate authorization, for storage and sharing of information.

As used herein, the term “media” means at least one of a RAM, A ROM, a disk, a DVDROM, a CDROM, an ASIC, a PROM, or any other type of storage means.

As used herein, the term “network” means a group of two or more computers linked together. There are many types of networks, including: local-area networks (LANs), where the computers are geographically close together, typically, in the same building, and wide area networks (WANs) where the computers are farther apart and are connected by telephone lines or radio waves.

In addition to these types, the following characteristics are also used to categorize different types of networks: topology is the geometric arrangement of a computer system (common topologies include a bus, a star, and a ring); the protocol defines a common set of rules and signals that computers on the network use to communicate (one of the most popular protocols for LANs is called Ethernet). Networks can be broadly classified as using either a peer-to-peer or client/server architecture. Computers on a network are sometimes called nodes. Computers and devices that allocate resources for a network are called servers.

In various embodiments, the system and method provide electronic control modules, fitted with a low-cost graphic display, which is capable of displaying a wealth of diagnostic and operational state information. The electronic control modules can be configured to operate in various modes of operation to provide diagnostic and operational state information. For example, in one embodiment, the electronic control module can be configured to perform self-diagnostic. In another embodiment, the electronic control module can be configured to provide remote diagnostic of an external device.

The embodiments relate to the conveyance of this data by using a dynamic indication system, which can be read by a handheld smart device comprising a camera. This dynamic indication system may be a single or sequence of flashes, barcodes, icons, or glyphs, commonly referred to as glyphs or QR codes or other visual data communication method. This system is an enabling technology that can be used to convey to an application on the handheld device both static and dynamic information.

In the embodiments, the static information provided can be used, for example, to indicate manufacturer, model, serial number, mac addresses, look up stock quantities for the module, and/or generate the task of ordering replacement modules.

Dynamic information that is provided far exceeds information available from traditional led indicators and basic error messages. The dynamic information may include complicated strings or data, which can be conveyed to a smart device that is capable of enabling many actions. An example list of some of the actions enabled by the device may include, but not limited to: displaying register values, schematics, assigned media access control (MAC) and Internet protocol (IP) addresses, system configuration, check replacement stock, order replacement parts, troubleshoot system faults and warnings, confirm equipment certifications, etc.

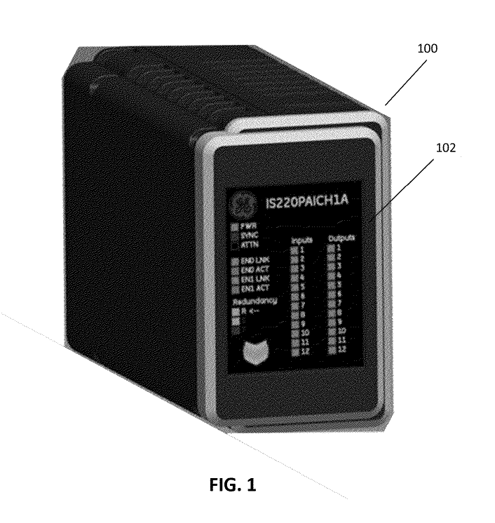

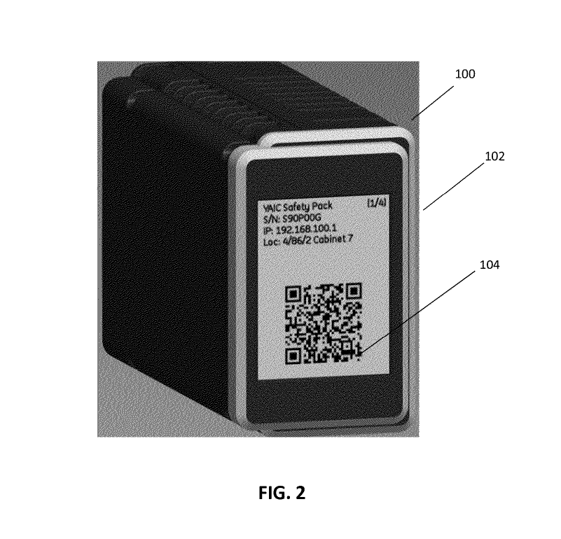

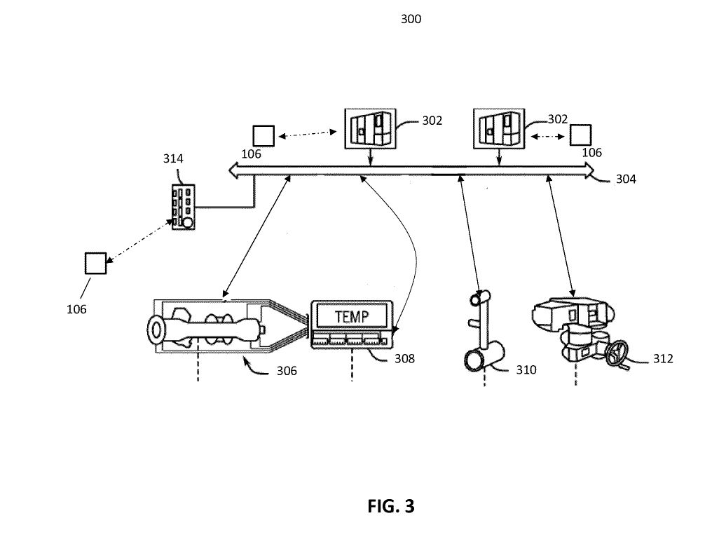

FIGS. 1-2 illustrate an electronic control module 100 for monitoring and diagnosing the condition of a remote device (shown in FIG. 3) or for performing self-diagnosis. The electronic control module 100 includes a housing that encloses a graphical display 102. The electronic control module 100 is equipped with a display 102 for displaying diagnostic and operational state information.

In a self-diagnostic mode, the system is capable of performing an internal diagnostic to identify a source of error of sensors within the electronic control module 100. The electronic control module can be configured to display, for example, fault conditions which may be internal or wiring related. Thus, various embodiments relate to a self-diagnostic system that enables even an unskilled person to identify the source of a problem in the electronic control module 100 easily and in a relatively short time and without using any special measuring equipment.

The self-diagnosis system is capable of determining the health of the electronic control module 100 on the basis of internal system parameters such as voltage, current, or faulty wiring conditions. This list is merely exemplary and is not limiting. The self-diagnosis system employs one or more sensors configured to gather data indicative of the health and/or status of the electronic control module. The sensor data from each diagnostic sensor is processed to detect, locate, and characterize any error and/or fault condition that develops within the electronic control module.

The electronic control module 100 enables the easy conveyance of this diagnostic and operational data through of a dynamic indication system, which can be read by a portable handheld smart device 106 with a camera (FIG. 3). The handheld device may be a smart device, such as a personal computer, personal digital assistant (PDA), smartphone, tablet or the like.

In various embodiments, the dynamic indication system can be displayed as a single or sequence of flashes, barcodes, icons, or glyphs, hereafter referred to as glyphs or quick response (QR) codes 104, as shown in FIG. 2. The electronic control module 100 transmits the diagnostic and operational data in the form of a glyph 104, comprising both static and dynamic information, to an application on the portable handheld device 106 (FIG. 3).

By way of example, during normal operating mode, the graphic display 102 displays the current operating state information acquired from a device, as shown in FIG. 1. During use in a diagnostic mode, a person, such as a technician, a field engineer, or a consumer, using a portable handheld device approaches the electronic control module 100, launches the associated application on the handheld device, and scans the displayed glyph(s), or QRC 104. QRC 104 can also be a single or sequence of flashes, barcodes, icons, or glyphs, commonly referred to as glyphs or QR codes or other visual data communication method. The system is able to accurately convey very detailed module information, which is information otherwise hidden from the user within the electronic module.

In the embodiments, the static information can be used, for example, to indicate manufacturer, model, serial number, and MAC addresses. In addition, the static information can be used to look up stock quantities for a particular module and/or generate the ordering of replacement modules. Traditionally, such static information has been provided using labels affixed to the product. These labels can be damaged, hidden, or even fall off over time. These labels can be expensive, require custom printing, and may need to be replaced when the modules are re-worked or assembled mismatched.

The dynamic information provides information that far exceeds traditional information, which is available from conventional led indicators and basic error messages. In various embodiments, complicated strings or data can be transmitted to a handheld smart device that enables many actions. An exemplary list of some of the actions enabled include, but are not limited to: display register values, schematics, assigned MAC and IP addresses, system configuration, check replacement stock, order replacement parts, troubleshooting system faults and warnings, confirm equipment certifications, etc.

The electronic control module 100 illustrated in FIG. 2 includes a housing that includes a graphical display 102, which uses a dynamic indication system to display a QR code, such as a glyph, associated with state information acquired from a corresponding device.

In FIG. 2, the exemplary QR 104 is a two-dimensional visual data pattern that is used to provide a user with rapid access to information embedded in the codes. The codes are easily captured by a user's digital camera and then decoded to obtain information. The exemplary depicted QR code 104 represents a barcode matrix, which includes multiple regions or area containing specific visual indicia, which are encoded to provide machine readable data. The data may be encoded as numeric, alphanumeric, or binary data.

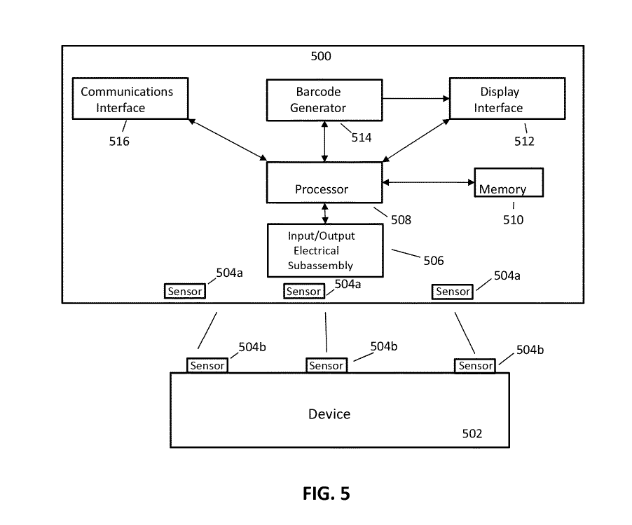

Using visual indicia, the electronic control module 100 is able to quickly convey to the user detailed diagnostic information associated with the corresponding device. When in use in the diagnostic mode, an input or a command signal can be input manually or automatically to the electronic control module 100 to cause a QR code generator (FIG. 5) of the electronic control module to generate. Thus, the diagnostic function can be automatically or manually initiated.

In response, a QR code associated with the device's state information will be displayed on the graphic display 102. The user can capture an image of the QR code 104 or other two-dimensional visual indicia using the camera of the handheld wireless device to obtain both static information and dynamic information about the device. The software application running on the handheld device 106 then decodes the two-dimensional indicia obtaining the embedded information.

Thus, the electronic control module eliminates the need for the user to manually record and document information regarding the device when troubleshooting a suspected malfunctioning, because the device's state information is transmitted via the QR code downloaded.

As described above, the device's status information encoded in the QR code includes both static information and dynamically changing information. The static information provided can be used, for example, to indicate manufacturer, model, serial number, mac addresses, look up stock quantities for the module, and/or generate the task of ordering replacement modules.

The dynamic information may include complicated strings or data that is capable of enabling many actions. An example list of some of the actions enabled by the device may include, but not limited to: displaying register values, schematics, assigned MAC and IP addresses, system configuration, check replacement stock, order replacement parts, troubleshoot system faults and warnings, confirm equipment certifications, etc. A QR code can be displayed if the device experiences a malfunction or error condition.

A change sensed in the state of an integrated module function such as an open or short wire, for example, by a sensor automatically causes a change in the dynamic information. This dynamic change causes the QR code generator (FIG. 5) to generate a new QR code. For example, the QR code generator generates a first dynamic QR code when the integrated module function is in one state and a different dynamic QR code when the integrated module function is in a second state. Thus, the QR code generator (FIG. 5) is able to dynamically change the QR code displayed according to the current state of the integrated module function.

Historical data related to the connected device may also be embedded within the QR code. The historical data may be associated with previous fault information of the device. For example, the historical data may include an identifier for a specific fault that occurred, the number of times that fault has occurred, and the parameter data obtained from the device at the time of the fault.

The historical data and the current device data encoded in the QR code can be used proactively in diagnostic maintenance and to predict future malfunctions. The prediction and/or information about the prediction may be processed by the computer within the electronic control module 100 and displayed within the QR code. This will enable a user, such as a technician or field engineer, to understand, preempt, and/or react to the predictive event.

The historical data may correlate past events and parameters with previous malfunctions, failures, shutdowns, trips, etc. Thus, the historical data may indicate the likelihood of the occurrence of an event. Using a comparison to the likelihood of occurrence based on the historical data, the predictive data may be derived by analyzing the device's current state information received at the electronic control module 100.

The electronic control module 100 provides a means for providing a detailed and succinct status indicator that is capable of identifying the underlying problems of a device malfunction. This is implemented as described above by using a visual indicator, such as a QR code or glyph, 2-dimensional barcode or other type of display indicator that is easily read by a portable handheld device. The most common visual indicator is a QR code, which can be either a standard-off-the shelf device or a customized reader application that connects to a specific network to provide a variety of status information, which is field treatable.

Typically, when a module indicates a fault condition, a red light or blinking indicator appears and this information is communicated to a controller and displayed on a human machine interface (HMI). Then, the control center dispatches a technician or field engineer to replace the suspected malfunctioning module. The technician logs the device for a return merchandise authorization (RMA) to return the product back to the manufacture to receive a refund, replacement or repair during the product's warranty period. Then, the RMA item is shipped back to the manufacturer and sent to a failure analysis lab with the basic error message and all attached paper documentation.

Typically, this replacement occurs by the technician without even consulting with the manufacturer. The device is just pulled and replaced with a new one. However, oftentimes, when the device reaches the failure analysis lab, no fault is found or the error may have been caused by a wiring configuration or a number of conditions, which are correctable in the field.

One of the advantages of the electronic control module 100 is that it enables status—binary information to be easily captured by the handheld device 106 and transmitted to the manufacturer. Thus, the manufacturer can possibly assist the technician during the onsite repair by providing helpful information to resolve the malfunction, disclosing information related to any known recalls, or informing the technician to replace the device with an updated model.

Another advantage is that the electronic control module conveys status information regarding devices not network connected. Many devices are not connected to a system network or directly connected to the Internet. The electronic control module enables this information to be easily captured by the handheld device and transmitted over a network to a manufacturer or another end user.

Further, the electronic control module is capable of providing to the manufacturer a granularity of operating data, which is typically not provided from the user back to the manufacturer. In various embodiments, the scanned QR codes will causes the software application on the handheld device 106 to initiate a connection with the manufacturer. The manufacturer can then analyze the collected data to detect trends to indicate whether a technician is continuously correcting, debugging or repairing the same problem or a particular path.

Therefore, before completing a replacement or repair part order, the device's downloaded status information provides the user with access to detailed information to complete a system diagnostics that confirms failure of a component.

In lieu of glyphs or QR codes, in other embodiments, the data may be obtained through the use of optical character recognition. In such embodiments, scanned or photographed images of typewritten or printed text can be mechanically or electronically converted into machine-encoded/computer-readable text. The printed text is digitized so that they can be electronically edited, searched, stored, displayed online and used in a machine process.

FIG. 5 illustrates an exemplary embodiment of the basic components that may be included within an electronic control module 500. In FIG. 5 for performing self-diagnostics, one or more internal sensors 504a, such as open wire sensors, tamper sensors, under or over-voltage sensors, etc., are located within electronic control module. In FIG. 5 for performing remote diagnostics, one or more sensors 504b are attached at predetermined location to a remote device 502. Sensors 504b may be integrated into a housing of the device 502 or may be removably attached to the housing. Each sensor 504a, 504b can generate sensor data that is used by the electronic control module 500.

As used herein, a “sensor” is a device that measures a physical quantity and converts it into a signal which can be read by an observer or by an instrument. In general, sensors can be used to sense light, motion, temperature, magnetic fields, gravity, humidity, vibration, pressure, electrical fields, sound, and other physical aspects of an environment.

Non-limiting examples of sensors can include tamper sensors, acoustic sensors, vibration sensors, vehicle sensors, chemical sensors/detectors, electric current sensors, electric potential sensors, magnetic sensors, radio frequency sensors, environmental sensors, fluid flow sensors, position, angle, displacement, distance, speed, acceleration sensors, optical, light, imaging sensors, pressure sensors and gauges, strain gauges, torque sensors, force sensors piezoelectric sensors, density sensors, level sensors, thermal, heat, temperature sensors, proximity/presence sensors, etc.

The exemplary electronic control module 500 includes an input/output electrical subassembly 506, a processor 508, memory 510, a display interface 512, a barcode generator 514, and a communication interface 516. Processor 508 executes machine language program instructions. The input/output electrical subassembly 506 can be initialized by the instructions in the machine language program code to perform an input/output function, which converts electrical signals to input/output table values.

The electrical signals are received at respective connection terminals through connecting signal lines (also referred to as signaling the state of the input/output channels). Memory 510 is used by processor 508 to store the input/output data in to tables. Barcode generator 514 is used to generate a two-dimensional bar code, such as a QR code or glyph, which is displayed via the display interface 512, as shown in FIG. 2.

The display interface 512 is also used to receive instructions from the processor to display the operating state data of the device, as shown in FIG. 1. The communication interface 516 is configured to conduct a wireless data transmissions session with a handheld device to read and transmit data embedded within the two-dimensional bar code.

As depicted in FIG. 3, a variety of devices can benefit from the electronic control module 100, 500 described herein. The module can be used in any device that comprises a processor that is capable of deriving status information, such as any device from a controller to a digital input/output module.

The module includes a special-purpose computer that executes a stored control program to read inputs from and provide outputs to the controlled device or process, based on the logic of the control program. The electronic module includes an electrical circuitry subassembly that converts the electrical signals used in a field device into electronic signals that can be used by a control system and translate real world values to input/output table values.

For example, the electronic control module is applicable to input/output modules, such as a power pack, programmable logic controller, one or more communication modules, and input/output modules for connecting signal lines that lead into device or an industrial process to be controlled. These input/output modules have channel status displays, which are typically implemented using LEDs. For example, the electronic controller module 100 may be included within devices from a gas turbine system to a dishwasher. In various embodiments, the device may be a standalone device, which is not connected to a network. In other embodiments, the device may be a consumer electronic device or industrial device connected to a network.

FIG. 3 illustrates a network environment where numerous components are connected. The system is able to easily and accurately identify module state and fault information with the press of a button, which simplifies site maintenance. In FIG. 3, an industrial control system 300 is illustrated.

The illustrated industrial control system 300 includes industrial controllers 302 (e.g., a Mark™ Vie, or any other Mark™ industrial controller available from General Electric of Schenectady, N.Y.) that may be configured to operate in accordance with aspects of the present teachings. The system may include any number and suitable configuration of industrial controllers 302. For example, in some embodiments, the system 300 may include one industrial controller 302, two industrial controllers 302, three, or more industrial controller for redundancy.

Additionally, the industrial controller 302 may be coupled to a network 304 to control the operation of a number of field devices 306 (e.g., a turbine system), 308, 310, and 312. Industrial networks can be used to interconnect field devices with controllers. Common input/output networks include Profibus, ProfiNet, Device Net, Fieldbus, and others.

The industrial controllers 302 may enable control logic useful in automating a variety of plant equipment, such as a turbine system 306 (e.g., gas turbines steam turbines, hydro-turbines, and/or wind turbines), a valve 310, and a pump 312. Indeed, the industrial controllers 302 may communicate with a variety of devices, including but not limited to temperature sensors 308, flow meters, pH sensors, temperature sensors, vibration sensors, clearance sensors (e.g., measuring distances between a rotating component and a stationary component), and pressure sensors. The industrial controller 302 may further communicate with electric actuators, switches (e.g., Hall switches, solenoid switches, relay switches, limit switches), air separation units, gasifiers, compressors, gas treatment units, boilers, and so forth.

For the illustrated industrial control system 300, the turbine system 306, and the other field devices 308, 310, and 312 are communicatively coupled to the industrial controller 302 (e.g., via the network 304) while monitoring and controlling various aspects and parameters of the operation of the gas turbine system (e.g., monitoring the temperature in a combustor of the gas turbine system, controlling the voltage output of an electrical generator coupled to a shaft of the gas turbine system, regulating a flow of a fuel into the combustor, controlling a steam input of a heat recovery steam generator (HRSG), and the like). It should be appreciated that the illustrated industrial control system 300 represents a simplified industrial control system, and that other industrial control systems may include any suitable number of industrial controllers 302, networks 304, networking devices, field devices, etc., to monitor and control portions of any automated system.

In other embodiments, rather than a turbine system 306, the system being monitored and controlled by the industrial control system 300 may include, for example, any automated manufacturing systems (e.g., petroleum refinery systems, chemical production systems, gasification systems, or similar automated manufacturing system) or automated power generation systems (e.g., power plants, steam turbine systems, wind turbine systems, and similar automated power generation systems).

A variety of devices may be linked to the industrial controller 302. For example, in one embodiment, and input/output pack 314 may be coupled to the network 304. The input/output pack 314, (e.g. I/O pack, part number IS220PAICH1A available from General Electric), may provide for the attachment of additional sensors and actuators to the system 300.

In certain embodiments, the devices 306, 308, 310, and 312 may provide data, such as alerts, state or measurement data, to the system.

In the exemplary embodiment shown in FIG. 3, the electronic control module 100 can be applicable to the controllers 302, the input/output pack 314 or both. According to the present teachings, controllers 302 and the input/output pack 314 may be equipped with a graphic display 102 (FIGS. 1-2) which is capable of converting the parameter data to a QR code readable by a handheld portable device 106 including a camera, as described above.

Controllers 302 and the input/output pack include a memory and a processor to process the parameter data of the components within the system 300 (e.g., compressors, turbine blades, valves (e.g., control valve performance) switches, etc). The parameter data may be either digital or analog. For example, the data may include analog temperature and/or flow rate data and/or digital data such as Boolean status data pertaining to the state of various components within the system 300.

In FIG. 3, when the technician receives a report of a malfunctioning device, using a portable handheld device 106 comprising a camera, such as a smartphone, the technician launches the diagnostic application running on the handheld device. A request can be input manually or automatically through a HMI into the electronic control module, which in turns causes the electronic control module to generate and display a QR code. Then, the technician aims the camera at the QR code to read the information embedded within the QR code.

The application running on the handheld device extracts the data from the pattern of the QR code and analyzes the data to derive diagnostic information. The diagnostic information may be used by the technician to troubleshoot the malfunctioning device. The retrieved data can include, for example, plant diagrams, bills of materials, and lockout/tagout (LOTO) information. In addition, the diagnostic information may be transmitted over a network, such as the Internet, to a manufacturer for technical assistance with the repair or data collection.

Thus, in addition to the immediate customer benefits, the system also facilitates greater interaction between the manufacturer and the customer. Some usage examples include: automated manufacturer notification of site module failure with details; simplified RCA process due to more accurate data collection; simplified communication of module troubleshooting information; automated instructions regarding whether a faulted module should be discarded, returned for evaluation, or superseded by a new part number.

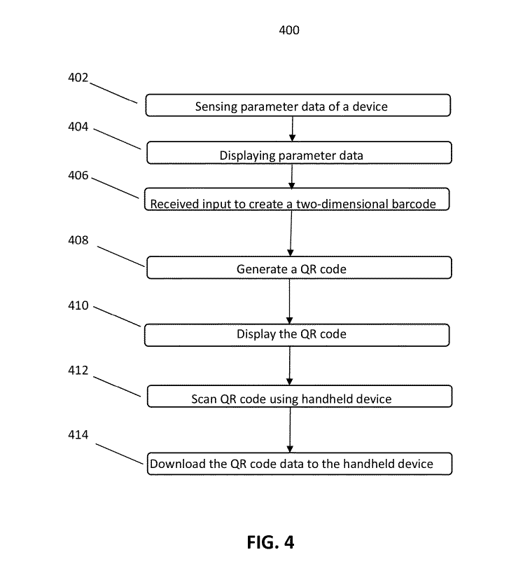

FIG. 4 illustrates an embodiment of a process 400 for diagnosing and troubleshooting maintenance of a device using an electronic control module in accordance with the present teaching. In Step 402, the system senses parameter data, including static information and dynamic information, of a device. In Step 404, the parameter data is displayed on a graphical display.

In Step 406, an input is received to create a readable two-dimensional barcode using the parameter data received from at least one device. In Step 408, a QR code embedded with the static and dynamic information is generated. In Step 410, the QR code is displayed on the graphical display. In Step 412, the displayed QR code is scanning by using a camera of a handheld device. In Step 414, the information embedded within the code is downloaded to the handheld device using an application running on the handheld device.

The binary information captured by the handheld device can be transmitted to the manufacturer. Thus, the manufacturer can possibly assist the technician during the onsite repair by providing helpful information to resolve the malfunction, disclosing information related to any known recalls, assisting with RMAs or informing the technician to replace the device with an updated model.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

What is claimed is:

1. A control module including a display, comprising:
an input/output module configured to receive one or more signals responsive to a state of at least one diagnostic sensor, the state being indicative of at least one from the group including a fault, an error, and a malfunction;
a processor configured to evaluate said fault information and match it to a corresponding code; a barcode generator for creating a two-dimensional barcode representative of the code, the barcode being configured for output to the display.

2. The control module of claim 1, wherein the at least one diagnostic sensor is an internal diagnostic sensor within the control module.

3. The control module of claim 1, wherein the at least one diagnostic sensor is an external diagnostic sensor associated with an external device.

4. An electronic control module, comprising:
a housing;
at least one processing unit and at least one database;
an input/output module comprising an electrical circuitry subassembly enclosed within the housing, wherein the electrical circuitry subassembly is initialized by instructions in the at least one processing unit to perform an input/output function by converting electrical signals to input/output table values stored in the at least one database;
a barcode generator enclosed within the housing for generating a two-dimensional barcode embedded with an operating state of at least one diagnostic sensor; and
a communication interface configured to conduct a wireless transmission session over a network with a handheld device comprising a camera to capture an image of the two-dimensional code to decode and download data embedded within the two-dimensional barcode using a software application installed on the handheld device.

5. The electronic control module of claim 4, wherein the at least one diagnostic sensor is at least one of an internal diagnostic sensor within the input/output module and an external diagnostic sensor associated with an external device.

6. The electronic control module of claim 5, wherein the data embedded within the two-dimensional barcode comprises at least one of the static information and dynamic information.

7. The electronic control module of claim 5, wherein the two-dimensional barcode comprises at least one of the quick response (QR) code and visual data communication method.

8. The electronic control module of claim 5, wherein the barcode generator dynamically changes a pattern representation of the two-dimensional barcode upon receiving an input/output state change of the at least one of the internal diagnostic sensor and the external diagnostic sensor.

9. The electronic control module of claim 5, wherein the communication interface communicates the data embedded within the two-dimensional barcode to the handheld device for diagnosis and correction of an error condition in at least one of a device connected to a network and a device not connected to a network.

10. The electronic control module of claim 5, wherein the communication interface communicates data embedded within the two-dimensional barcode to the handheld device for predicting a probability of occurrence of a failure event or an alarm event.

11. The electronic control module of claim 5, wherein the communication interface communicates data embedded within the two-dimensional barcode to the handheld device to take preventative actions on a device when a probability of occurrence indicates a failure event or an alarm event will occur.

12. The electronic control module of claim 5, wherein the communication interface communicates data, embedded within the two-dimensional barcode to the handheld device, which includes at least one of repair instructions, replacement instructions and return instructions when a failure event or alarm event has occurred.

13. The electronic control module of claim 5, wherein the communication interface communicates data embedded within the two-dimensional barcode is based on current state data and historical data to the handheld device to proactively diagnose and predict future malfunctions in a device.

14. The electronic control module of claim 5, wherein the electronic control module comprises a controller, an input/output pack or a power pack.

15. A method for conveying data stored within an electronic control module, the method comprising:
receiving electrical signals at an input/output module responsive to a state of at least one diagnostic sensor;
performing an input/output function by converting the electrical signals to input/output table values, which are stored in at least one database;
generating a two-dimensional barcode embedded with an operating state of the at least one diagnostic sensor;
conducting a wireless transmission session over a network with a handheld device comprising a camera to capture an image of the two-dimensional code; and
decoding and downloading data embedded within the two-dimensional barcode using a software application installed on the handheld device.

16. The method of claim 15, wherein the at least one diagnostic sensor is at least one of an internal diagnostic sensor within the input/output module and an external diagnostic sensor associated with an external device.

17. The method of claim 16, wherein the data embedded within the two-dimensional barcode comprises at least one of the static information and dynamic information.

18. The method of claim 16, wherein the two-dimensional barcode comprises at least one of the quick response (QR) code and visual data communication method

19. The method of claim 16, further comprising dynamically changing a pattern representation of the two-dimensional barcode upon receiving an input/output state change of at least one input/output channel.

20. The method of claim 16, further comprising communicating the data embedded within the two-dimensional barcode to the handheld device for diagnosis and correction of an error condition in at least one device.
